(19) United States
(12) Patent Application Publication
(10) Pub. No.: US 2026/0211229 A1
(43) Pub. Date: Jul. 23, 2026

(54) APPARATUS, A SYSTEM AND A METHOD FOR MULTIBAND EVENT-BASED IMAGING

(71) Applicant: Accenture Global Solutions Limited, Dublin 4 (IE)

(72) Inventors: Eric Michael GALLO, Moretown, VT (US); Lavinia Andreea Danielescu, Seattle, WA (US)

(73) Assignee: Accenture Global Solutions Limited, Dublin 4 (IE)

(21) Appl. No.: 19/028,992

(22) Filed: Jan. 17, 2025

(51) Int. Cl. G02B 26/00; H04N 25/13; H04N 25/47

(52) U.S. Cl. CPC G02B 26/007; H04N 25/13; H04N 25/47

(57) ABSTRACT

Disclosed is an apparatus, a system and a method for multiband event-based imaging. The apparatus includes, an optical focusing component to capture and focus incident light from an object in a scene, a multi-band spectral filter assembly to receive and filter the incident light from the optical focusing component, an event sensor including a pixel array to detect one or more events, including sensing a change in relative intensity over time for filtered light received from the multi-band spectral filter assembly, and a filter assembly driver to sweep the multi-band spectral filter assembly in front and across the pixel array of the event sensor, and along a plane of motion perpendicular to the multi-band spectral filter assembly.

### TECHNICAL FIELD

The present disclosure generally relates to imaging systems and, more specifically, relates to an apparatus, a system and a method for multiband and/or hyperspectral event-based imaging.

### BACKGROUND

Multiband and hyperspectral imaging allow the extraction of wavelengths beyond the typical RGB sensors found in standard cameras. Multiband and hyperspectral imaging systems obtain detailed spectrum information for each pixel in a scene and create images that provide higher resolution on the spectrums of light present in a scene. Such types of cameras are used in various fields for different purposes.
Remote Sensing: Used to capture detailed information about the Earth's surface. This data is used for environmental monitoring, land cover classification, agriculture analysis, and urban planning.
Agriculture: Used to monitor crop health, detect diseases, and optimize irrigation and fertilization practices, helping farmers make informed decisions to improve crop yield and reduce resource wastage.
Environmental Monitoring: Assess and monitor environmental conditions such as water quality, vegetation health, and pollution levels. They provide valuable data for conservation efforts and environmental management.
Geology and Mineralogy: Used in geological surveys to identify and map different types of rocks, minerals, and geological formations.
Forestry: Used to monitor forest health, detect tree species, and assess the extent of deforestation. They help in forest management, biodiversity conservation, and wildfire detection.
Medical Imaging: Hyperspectral imaging is used in medical applications for non-invasive diagnosis and monitoring of diseases. It can provide detailed information about tissue composition, blood flow, and oxygenation levels, aiding in early detection and treatment planning.
Food Quality and Safety: Used to assess the quality and safety of food products. It can detect contaminants, determine freshness, and identify defects in fruits, vegetables, and other food items.

Further, the multiband and hyperspectral imaging systems are used in disaster assessments, military, manufacturing and food production. In conventional multiband and hyperspectral imaging, optical front ends are used to scan through wavelengths to capture consecutive images on a frame-based camera, such as with a push broom or whisk broom configuration. While such approaches allow for the collection of pixel-level spectrum data, these approaches have various limitations, including significant time needed for data acquisition. Additionally, conventional multiband and hyperspectral imaging systems rely on complex front-end optics for wavelength scanning, and the output consists of a large volume of individual wavelength images. Other methods such as snapshot hyperspectral imagers capture the spectrum in a single integration but also require complicated optics and an image sensor with a large enough resolution to capture each individual wavelength per pixel.

### SUMMARY

This section is provided to introduce certain objects and aspects of the present disclosure in a simplified form that are further described below in the detailed description. This summary is not intended to identify the key features or the scope of the claimed subject matter.

Embodiments of the present disclosure disclose an apparatus for multiband and/or hyperspectral event-based imaging. The apparatus includes, an optical focusing component to capture and focus incident light from an object in a scene, a multi-band spectral filter assembly to receive and filter the incident light from the optical focusing component, an event sensor including a pixel array to detect one or more events, including sensing a change in relative intensity over time for filtered light received from the multi-band spectral filter assembly, and a filter assembly driver to sweep the multi-band spectral filter assembly in front and across the pixel array of the event sensor, and along a plane of motion perpendicular to the multi-band spectral filter assembly.

Further disclosed is a system for multiband and/or hyperspectral event-based imaging. The system includes a processor, an event camera, a display device and a non-transitory memory device storing instructions. The event camera includes, an optical focusing component to capture and focus incident light from an object in a scene, a multi-band spectral filter assembly to receive and filter the incident light from the optical focusing component, an event sensor including a pixel array to detect one or more events, including sensing a change in relative intensity over time for filtered light received from the multi-band spectral filter assembly, and a filter assembly driver to sweep the multi-band spectral filter assembly in front and across the pixel array of the event sensor, and along a plane of motion perpendicular to the multi-band spectral filter assembly. The instructions stored in the non-transitory memory device when executed by the processor causes the processor to generate a multi-dimensional data matrix of event intensity values over time, wherein the event intensity values are associated with detection of the one or more events, identify an aspect of interest associated with the object in the scene based on analysis of the multi-dimensional data matrix, and display the aspect of interest associated with the object in the scene on the display device.

Further disclosed is a method for multiband and/or hyperspectral event-based imaging. The method includes, capturing and focusing incident light from an object in a scene, sweeping a multi-band spectral filter assembly in front and across a pixel array of an event sensor, and along a plane of motion perpendicular to the multi-band spectral filter assembly, and filtering, via the multi-band spectral filter assembly, the incident light to detect one or more events, including sensing a change in relative intensity over time for filtered light received from the multi-band spectral filter assembly. The method further includes, generating a multi-dimensional data matrix of event intensity values over time, wherein the event intensity values are associated with detection of the one or more events, generating a spectrum of incident light for each pixel of the pixel array, and identifying an aspect of interest associated with the object in the scene based on analysis of the multi-dimensional data matrix.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF DRAWINGS

The accompanying drawings, which are incorporated herein, and constitute a part of this disclosure, illustrate exemplary embodiments of the disclosed methods and systems in which like reference numerals refer to the same parts throughout the different drawings. Components in the drawings are not necessarily to scale, emphasis instead being placed upon clearly illustrating the principles of the present disclosure. Some drawings may indicate the components using block diagrams and may not represent the internal circuitry of each component. It will be appreciated by those skilled in the art that disclosure of such drawings include the disclosure of electrical components, electronic components or circuitry commonly used to implement such components.

FIG. 1A depicts an exemplary apparatus for hyperspectral imaging, in accordance with an embodiment of the present disclosure;

FIG. 1B depicts an exemplary apparatus for multiband event-based imaging with pinhole optics, in accordance with an embodiment of the present disclosure.

FIG. 2 depicts a method of transforming incoming signals with varying intensity into a time series of data point;

FIG. 3 depicts a block diagram of a system for multiband event-based imaging, in accordance with an embodiment of the present disclosure;

FIG. 4A depicts an implementation of a discrete filter bank made of tiled wavelength filters, in accordance with an embodiment of the present disclosure;

FIG. 4B depicts an implementation of a discrete filter bank made of tiled wavelength filters with blanks, in accordance with an embodiment of the present disclosure;

FIGS. 4C and 4D depicts a discrete filter bank in a spinning wheel arrangement and a discrete filter bank with blanks in a spinning wheel arrangement respectively, in accordance with an embodiment of the present disclosure;

FIGS. 5A, 5B and 5C depict the actual wavelength distribution on a single pixel, the event outputs as the discrete set of filters pass in front of the pixel, and a reconstructed spectrum based on the event outputs, respectively;

FIG. 6A depicts an implementation of a continuously variable band pass filter with an event camera, in accordance with an embodiment of the present disclosure; and

FIGS. 6B and 6C depict exemplary graphs illustrating an output of the continuously variable band pass filter arrangement.

### DETAILED DESCRIPTION

In the following description, for the purposes of explanation, various specific details are set forth in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address all of the problems discussed above or might address only some of the problems discussed above. Some of the problems discussed above might not be fully addressed by any of the features described herein.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the disclosure as set forth.

Specific details are given in the following description to provide a thorough understanding of the embodiments. However, it will be understood by one of ordinary skill in the art that the embodiments may be practiced without these specific details. For example, systems, processes, and other components may be shown as components in block diagram form in order not to obscure the embodiments in unnecessary detail. In other instances, well-known processes, structures, and techniques may be shown without unnecessary detail in order to avoid obscuring the embodiments.

Also, it is noted that individual embodiments may be described as a process which is depicted as a flowchart, a flow diagram, a flow diagram, a structure diagram, or a block diagram. Although a flowchart may describe the operations as a sequential process, many of the operations can be performed in parallel or concurrently. In addition, the order of the operations may be re-arranged.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes”,” “has,” “contains,” and other similar words are used in either the detailed description or the claims, such terms are intended to be inclusive—in a manner similar to the term “comprising” as an open transition word—without precluding any additional or other elements.

Reference throughout this specification to “one embodiment” or “an embodiment” or “an instance” or “one instance” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Embodiments of the present disclosure disclose an apparatus, a system and a method for multiband and/or hyperspectral event-based imaging. In one embodiment of the preset disclosure, the apparatus for multiband and/or hyperspectral event-based imaging (herein after referred to as hyperspectral imaging system) includes an optical focusing component to capture and focus incident light from an object in a scene, a multi-band spectral filter assembly to receive and filter the incident light from the optical focusing component, and an event sensor including a pixel array to detect changes in the light intensity, that is, changes to the incident intensity (events) and a filter assembly driver to sweep the multi-band spectral filter assembly in front and across the pixel array of the event sensor, and along a plane of motion perpendicular to the multi-band spectral filter assembly or along a path such that each individual pixel is exposed to all wavelengths present in the filter.

The system for multiband event-based and/or hyperspectral imaging includes the apparatus, a processor, a display device and a non-transitory memory device storing instructions. The instructions when executed by the processor causes the processor to, generate a multi-dimensional data matrix of changes in intensity values over time, wherein events are triggered by the changes in the intensity of light values incident on a pixel. The multi-dimensional matrix can be used to identify an aspect of interest and extract additional information from an object in the scene based on analysis of the multi-dimensional data matrix, and display the optical property being measured, such as the optical spectrum of wavelengths or the polarization map of the object on the display device. The system may be further configured to display a two-dimensional map of peak wavelengths present or filter to map a particular wavelength's relative intensity at each point.

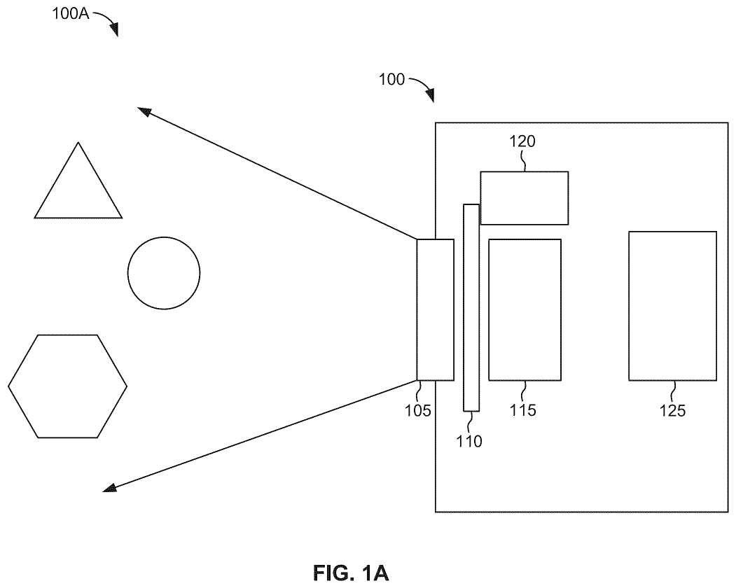

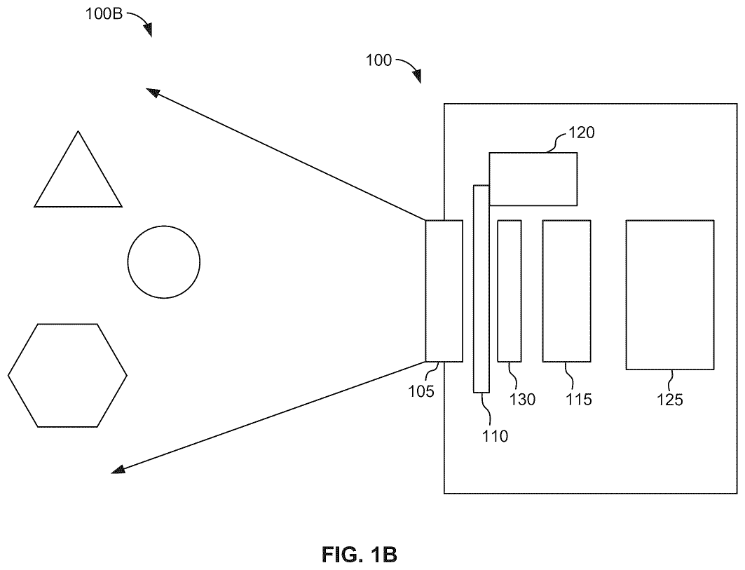

FIG. 1A depicts an exemplary apparatus for multiband event-based imaging, in accordance with an embodiment of the present disclosure. As shown the apparatus 100 (an event camera) includes an optical component 105, a multi-band spectral filter assembly 110, an event sensor including a pixel array 115, and a filter assembly driver 120. FIG. 1B depicts an exemplary apparatus for multiband event-based imaging with pinhole optics, in accordance with an embodiment of the present disclosure. As shown, the apparatus includes a pinhole lens 130 in addition to all the other components shown in FIG. 1A. In the configuration shown in FIG. 1A, the optical components 105 are configured to focus the light rays and hence includes focusing components. In contrast, the configuration shown in FIG. 1B includes non-focusing optics and includes the pinhole lens 130 between the multi-band spectral filter assembly 110 and the event sensor including a pixel array 115.

The optical component 105 includes one or more lenses which use refraction to converge light rays, focusing the light rays to form an image or project the light rays onto a surface. Hence, the optical component 105 captures and focuses the light emitting from one or more objects in a scene to the multi-band spectral filter assembly 110.

In one embodiment, the filter assembly 110 may be a linear varying filter configured to gradually change its center wavelength or polarity across a specified area. Other types of filter assemblies 110 which may be used include band pass filters, long pass filters, short pass filters, and dichroic filters. Such filters may be arranged between the optical component 105 and the event sensor including a pixel array 115 and driven using the filter assembly driver 120. Further, such filters may be arranged in various shapes, such as in a disc/wheel shape or a quadrilateral shape, to allow different wavelengths of light to sequentially reach each pixel as the filter assembly 110 moves. Areas where no light is allowed through, referred to as blanking regions, act as references for the system, triggering events in all pixels and providing signals to mark the beginning and end of data collection. In one implementation, the filters are organized in the filter assembly 110 in an increasing or decreasing order of wavelengths.

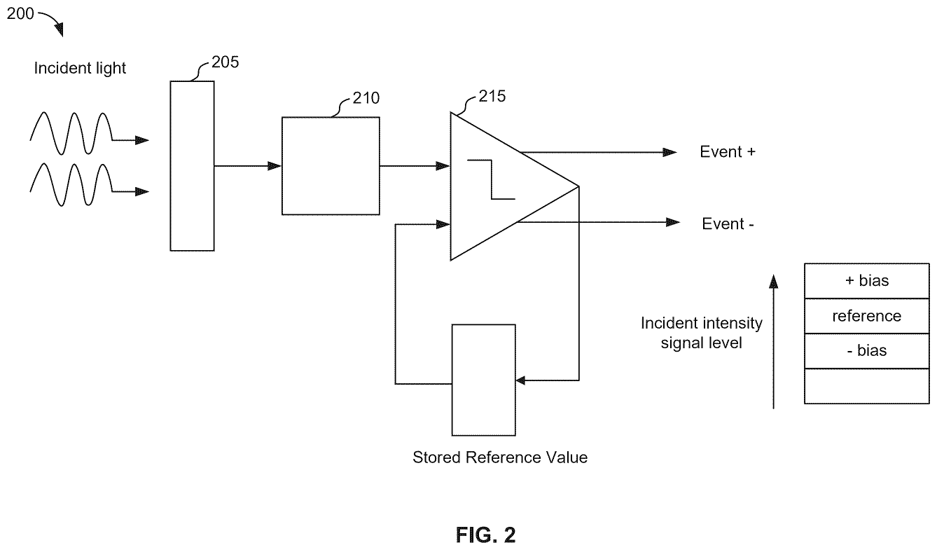

The event sensor including a pixel array 115 captures changes in a scene based on variations in light intensity at high rate (greater than one millisecond). The event sensor including a pixel array 115 may include a pixel array ranging from (1×1) to (N×M). Each pixel reports relative changes over time, indicating whether the intensity has increased or decreased. The actual value of intensity change that triggers an event is influenced by the pixel's bias settings, which users may adjust to customize the sensitivity based on the specific application needs. The pixel architecture of the apparatus 100 operates similarly to a delta-sigma analog-to-digital converter (ADC), transforming incoming signals with varying intensity into a time series of events, indicating an increase or decrease in incident intensity. An event may be referred to as 1 or −1 to indicate a threshold of change occurred in either a positive or negative direction. The event may be represented as a single bit in a camera readout, 0 for a negative polarity change, 1 for a positive polarity change. The threshold for change is determined by the assigned pixel bias. FIG. 2 depicts a method of transforming incoming signals with varying intensity into a time series of data point. As shown, constant light intensity incident on a pixel photodetector 205 creates a constant output signal from the amplifier 210. The intensity signal is compared to a previous intensity value (a reference) by a comparator 215. If the incoming signal is above or below the previous value by greater than the bias value, an event is generated, and the current intensity value is stored as the new reference value. The process is continued when the incident intensity changes again by a value greater than or equal to the bias value in the positive or negative direction. Hence, the pixel only outputs a signal when the intensity increases by a positive bias value or decreases by a negative bias value.

The time series of data points enables the reconstruction of intensity over time, allowing for the extraction of spectral curves when the filter assembly 110 is continuously moved in front of the sensor, or when different spectral filters are sequentially applied. As a result, apparatus 100 provides a unique platform for compact, high-speed multiband and/or hyperspectral imaging, utilizing either a physically moving filter or an electronically adjustable filter. The capture speed of images is limited by the pixel's refractory period and the sensitivity settings configured for each pixel. Such an approach results in a multi-band imaging solution that retains the normal functionality of the imager for standard event-based imaging while enabling spectral scans to gather multiband information. Multiband imaging may be conducted continuously or triggered by external factors, such as user actions or algorithms that detect the need for spectral data. The system allows for customizable spectral interrogation, capable of assessing three distinct wavelengths or using a continuous filter across a range of wavelengths. The filter assembly 110 may be compact, as the filter assembly 110 does not need to cover the entire event sensor. For example, a thin strip just a few pixels wide may effectively extract a multispectral image set. Additionally, the data is tagged with the event time and pixel address, facilitating reconstruction of the spectrum at each pixel.

Referring to FIG. 1A and FIG. 1B, the filter assembly driver 120 includes electromechanical elements configured to manage the positioning of the filter assembly 110, allowing the filter assembly 110 to move across the event sensor including a pixel array 115 at a predefined frequency or predefined speed. The filter assembly driver 120 may be configured to move the filter assembly 110 either linearly, rotationally or in a defined path, depending on the specific design of the filter assembly 110. The filter assembly driver 120 is configured to move the filter assembly 110 at a controlled rate or continuous rate providing time stamped position data for analysis. Alternatively, the filter can incorporate ‘blanks’ enabling the wavelength positions to be extrapolated from the collected event streams, allowing for accurate timing in capturing events or spectral data. In one embodiment, a user may adjust filter settings, movement speed, and other parameters using a dedicated interface 125.

As described, the apparatus 100 for hyperspectral imaging includes the optical component 105 to capture and focus incident light from an object in a scene, the multi-band spectral filter assembly 110 to receive and filter the incident light from the optical focusing component, the event sensor including a pixel array 115 for sensing a change in relative intensity over time for filtered light received from the multi-band spectral filter assembly 110, and the filter assembly driver 120 to sweep the multi-band spectral filter assembly 110 in front and across the pixel array.

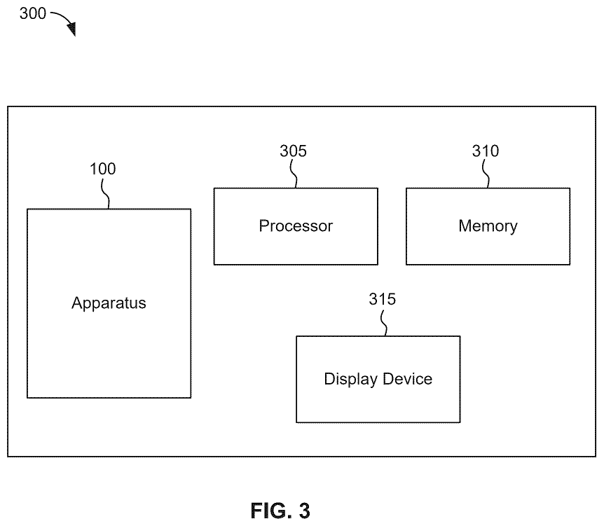

FIG. 3 depicts a block diagram of a system for hyperspectral imaging, in accordance with an embodiment of the present disclosure. As shown, the system 300 includes the apparatus 100, a processor 305, a memory 310 storing instructions to be processed by the processor 305, and a display device 315. It is to be noted that the processor 305 may be configured to control the operations of the apparatus 100. Alternatively, a dedicated processor may be implemented for controlling the operations of the apparatus 100. The system 300 may further include other components, including but not limited to, a network interface device for commuting the data, a user interface module, and image processing modules.

In one embodiment, system 300 may employ one or more methods to move the filter assembly 110 in front of the event sensor including a pixel array 115. The movement may be a single sweep, a rotational sweep, or a back-and-forth motion, at a controlled rate. Further, the movements may be in a set path that includes a sequence of x and y steps. As the filter assembly 110 passes over each pixel, the pixel experiences changes in intensity based on the light from the target scene that passes through the filter. By using linearly varying filters, the intensity changes occur smoothly over time, preventing abrupt shifts or singularities. The resulting changes are reported as asynchronous events, which indicate whether the intensity has increased or decreased, the timing of the change (usually measured in microseconds), and the pixel's location (x, y coordinates in the array). The resolution of such events is influenced by the pixel's bias, which determines the intensity change necessary for an event to be triggered. Data may be gathered continuously or during a single sweep, with multiple sweeps helping to reduce noise. For high or low pass filters, alternating forward and backward sweeps can also help eliminate artifacts caused by increasing optical band values.

During imaging, the data is collected for all pixels during the mechanical sweep of the filter assembly 110. The inclusion of filter ‘blanks’, which block all light, marks the start and end of the sweep, providing indicators within the collected data. Assuming a constant sweep rate, the center wavelengths of the filter may be correlated to time, linking events to specific filter values. Alternatively, stepper or position data may be collected simultaneously to establish the correlation. The event data may then be processed to produce an intensity versus wavelength output spectrum. The output spectrum displays relative intensity values in relation to adjacent wavelengths, highlighting increases or decreases in intensity as the incident wavelength or polarization varies. Additional information included in the analysis may enhance the results, such as corrections for illumination spectra, simulations of wide-band illumination through the filter, and individual pixel spectral absorption values.

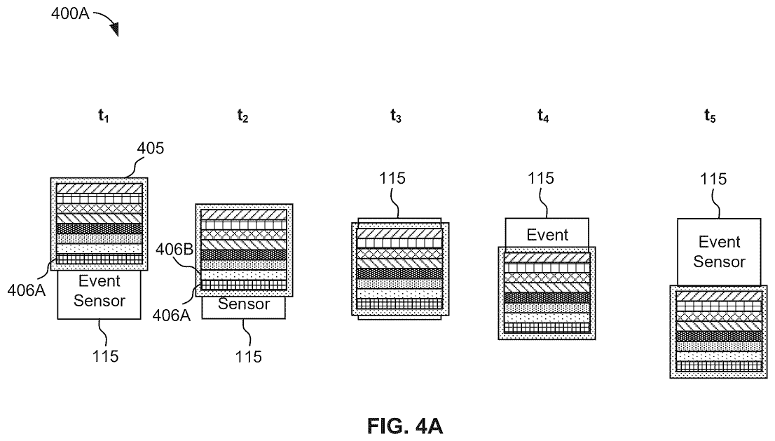

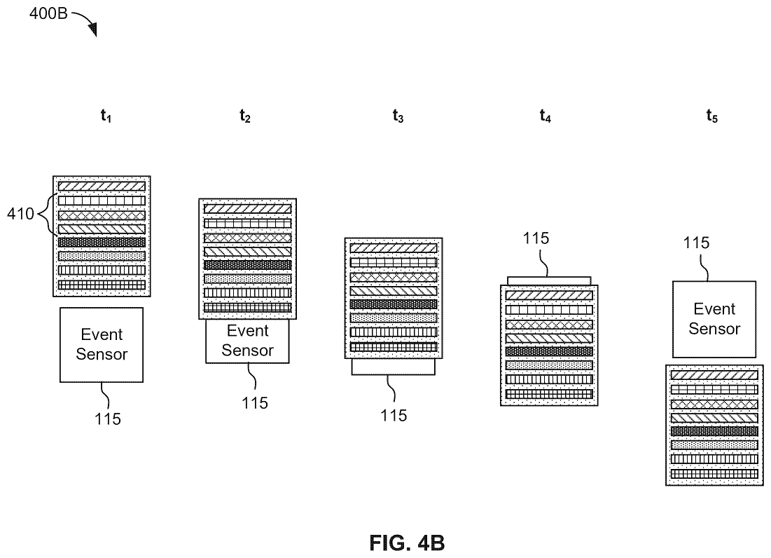

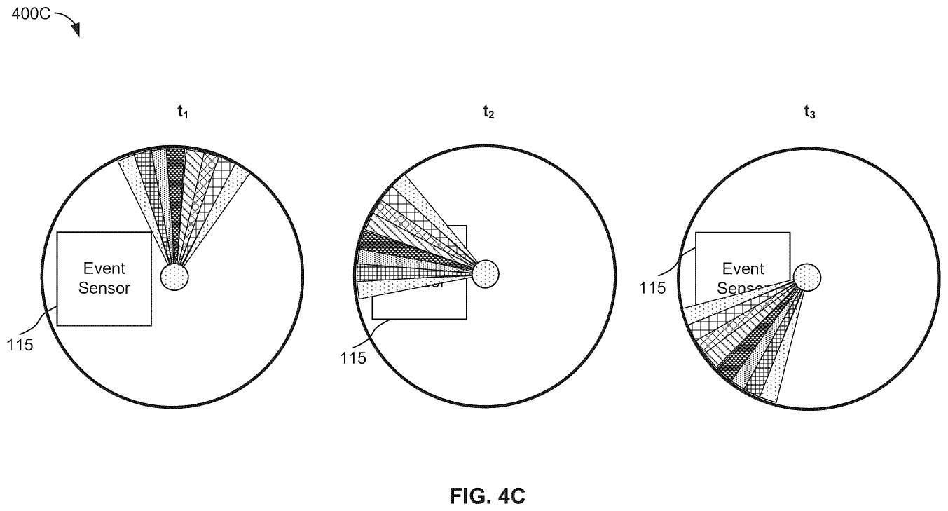

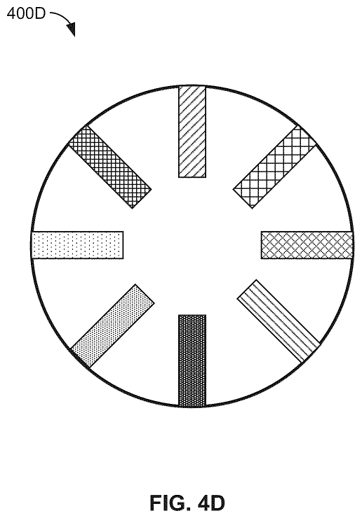

FIG. 4A depicts an implementation of a discrete filter bank made of tiled wavelength filters, in accordance with an embodiment of the present disclosure. It is important to note that the various color filters of the filter bank are shown in different patterns for illustrative purpose. For example, purple, green, yellow, orange, blue and red filters are shown with distinct patterns. Furthermore, a person skilled in the art would recognize that the discrete filter bank may include other color filters not limited to those described above. As shown, during spectrum acquisition, a discrete filter bank 405 is swept in front of the event sensor including a pixel array 115 (event image sensor). During the process, the initial ‘blank’ resets all pixels to their lowest intensity values. As the initial filter (purple color filter hereafter referred to as purple filter 406A) moves in front of the image sensor as shown at t₁, the pixels output events indicating the purple filtered light is different from the initial ‘blank’ state. The filter continues and green filter 406B replaces purple filter 406A as shown at t₂, events will indicate changes that occur in illumination intensities from purple to green, and the process continues as the full filter bank 405 passes in front of the image sensor 115.

The speed at which the filter bank 405 sweeps across the event sensor including a pixel array 115 is limited only by the pixel refractory period, typically 1 ms, and other parameters of the event camera such processing speed of the apparatus. The method uses a set of adjoining filters which reports the intensity differences relative to the previous spectrum when the filters are sequenced in increasing or decreasing center wavelength order as shown in FIG. 4A. FIG. 4B depicts an implementation of a discrete filter bank made of tiled wavelength filters with blanks in between each wavelength filter, in accordance with an embodiment of the present disclosure. With blanks 410, the filter sweep follows an opaque section that resets the pixel to the lowest intensity state in order to react to the next filter without comparing intensities. With such a method, a configuration that sweeps filters in front of the event sensor including a pixel array 115 may be of any shape, for example a spinning wheel configuration that rotates in front of the event sensor including a pixel array 115 at a predefined rotation speed. FIGS. 4C and 4D depict a discrete filter bank in a spinning wheel arrangement and a discrete filter bank with blanks in a spinning wheel arrangement respectively, in accordance with an embodiment of the present disclosure. It is to be noted that the filter spatial areas may also be tuned to provide minimum space, with size requirements dependent on the pixel size, speed of filter motion and proximity to the event sensor including a pixel array 115.

As described, the discrete filter bank made of tiled wavelength filters 405 when swept in front of the event camera generates a multi-dimensional data matrix of events over time, wherein the events are associated with discrete intensity value changes at the pixel. Then the system 300 identifies an area of interest, an object or a single pixel and displays the optical spectrum of the selection associated with the area of interest, the object or item on the display device. In one embodiment, a neural network (such as Convolutional Neural Networks (CNN) or Spiking Neural Networks (SNN)) may be implemented to analyze an object within a scene, extracting specific characteristics or aspects of the object. The aspects include the spectral properties (such as color or wavelength), and the polarity of the object. The neural network identifies and processes such properties through techniques such spectral analysis, and physical property detection.

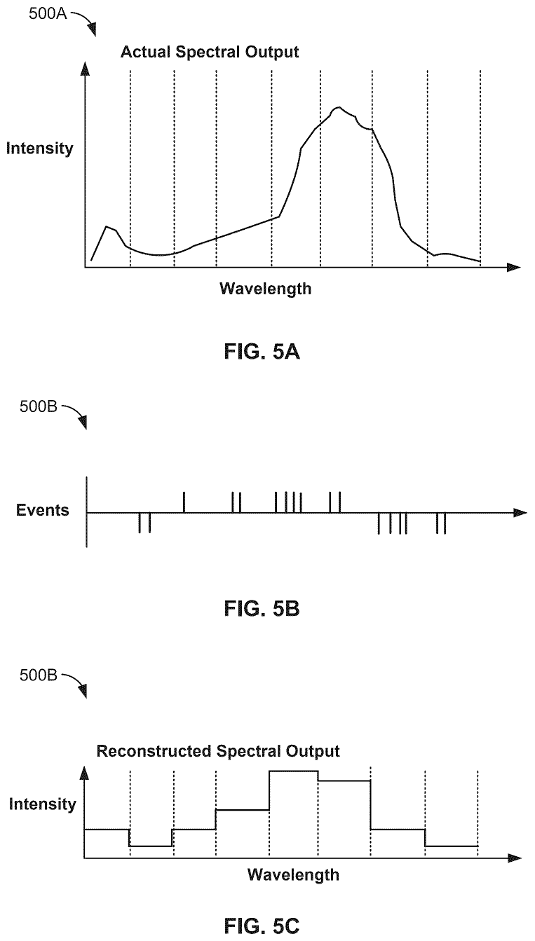

FIGS. 5A, 5B and 5C depict actual wavelength distribution incident on a single pixel, events generated as the discrete set of filters pass in front of the pixel, and a reconstructed spectrum based on the event outputs, respectively. As shown, without blanking, the event sensor including a pixel array 115 records differences between the intensities from one filter to another. This method enables spectral reconstruction with resolution dependent on the number of filters and the full width at half maximum (FWHM) of each filter. In contrast, with blanking between filters, the events will record the image received in the wavelength band of the filter sweeping across the filter, as the event sensor including a pixel array 115 does not record comparative values of intensities of the filters in the filter module. Such a method provides a binary image with the presence of light in the filtered wavelengths. The camera's event threshold value may be adjusted to determine the criteria for reporting of wavelengths. For example, the system may be configured to a minimum intensity threshold to record an event in a low light configuration. The threshold parameter may also be used and swept to extract high resolution spectra at the cost of time.

As described, in one embodiment of the present disclosure, a movable filter assembly is implemented to receive and filter the incident light from the optical component 105. In a second embodiment of the present disclosure, a tunable filter is implemented to receive and filter the incident light from the optical component 105. For example, a liquid crystal tunable filter (LCTF), which continuously modulates the center wavelength or transitions to an opaque state effectively, is used. Smooth, linear transitions between wavelengths ensure consistent light intensity, enhancing the overall output results and minimizing any potential disruptions.

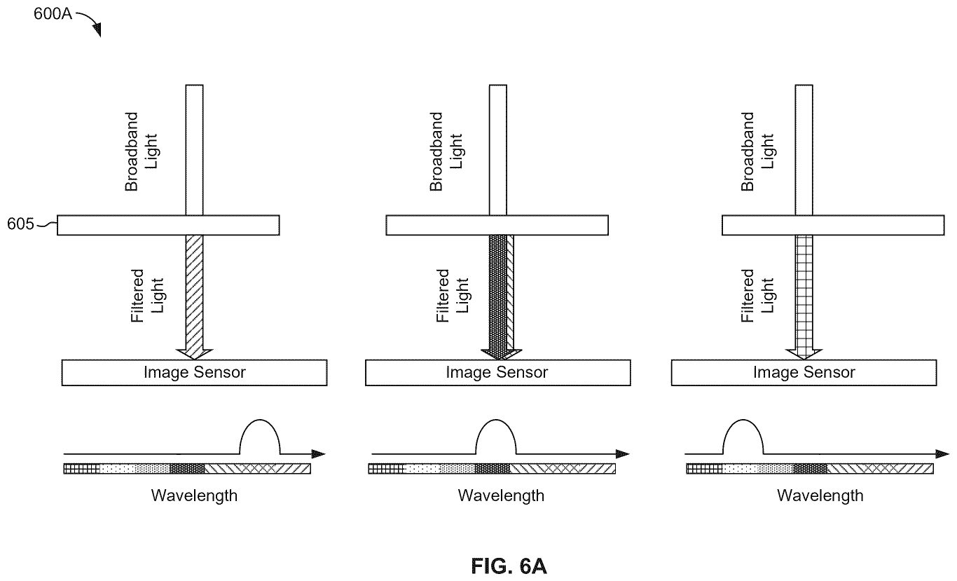

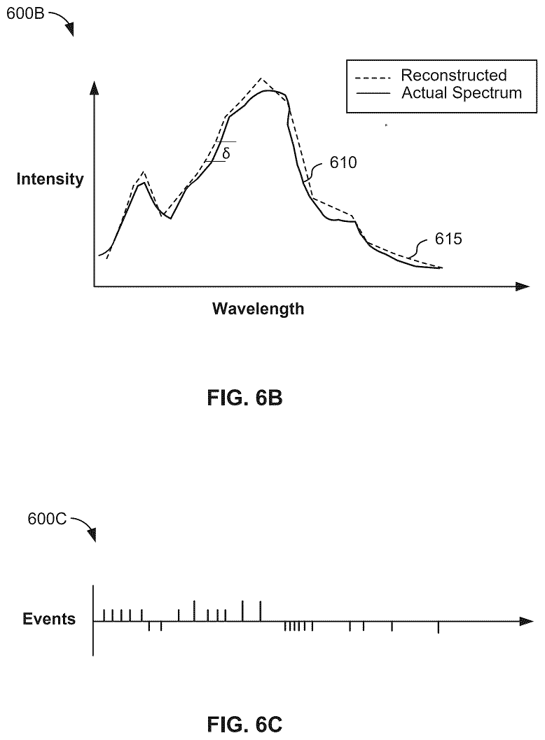

In a third embodiment of the present disclosure, a continuously variable band pass filter is implemented to receive and filter the incident light from the optical component 105. FIG. 6A depicts an implementation of a continuously variable band pass filter with the event camera, in accordance with an embodiment of the present disclosure. As the continuously variable band pass filter 605 moves in front of the event sensor including a pixel array 115, each pixel experiences changes in intensity based on the filter's center wavelength positioned in front of each pixel. The pixel detects a linear change in the incoming wavelength, leading to corresponding variations in intensity. The resolution achieved is influenced by the filter's FWHM, the speed of the filter strip, and the bias settings of the event-based camera. FIGS. 6B and 6C depict exemplary graphs illustrating an output of the continuously variable band pass filter arrangement. The graph 6B shows the actual spectral output (line 610) of an object as measured on a single pixel. As the linear filter continuously sweeps the incident wavelength, the pixel outputs the events indicating the intensity changes. The events as shown in 6C, show the wavelength at which the events occurred and thereby when the incident intensity changed by the threshold amount (bias value, set in the event sensor itself), resulting in a spiked output that may be reconstructed to the spectrum of the light incident on the pixel, shown by line 615.

It is to be noted that the speed of the filter and the spectral gradient Δλ/d , (change in center wavelength as a function of distance) governs the resolution. The resolution also depends on local FWHM of the band pass filter, spectral attenuation outside the peak, peak transmittance of the filter and on the derivative of the spectral output with respect to the wavelength. As the event sensor including a pixel array 115 reacts to a fixed intensity change, rapid changes in intensity require slower movement to fully capture the spectrum, while gradual changes may be captured with high accuracy.

The results provide individual spectra for each pixel viewing a scene and with post processing may allow for reconstruction of a color image after collection. Rastering the filter assembly 110 at variable speeds provides significant controls on the tradeoff between capture time and resolution and may be coupled with machine learning (ML) techniques to identify targets adjusting sweep speeds to acquire higher resolution spectral scans of objects or areas of interest. The method also serves as an ‘add-on’ to an event camera, maintaining all standard functions such as uses in event-based imaging, tracking, optical communications, and the like. Neural networks may be used downstream to account for imperfect filter characteristics, such as non-zero transmission of off-center wavelengths.

In a fourth embodiment of the present disclosure, an illuminator is implemented instead of a filter to illuminate an area of interest. The illumination may be spectrally selective (LEDs with different spectral outputs) or a filtered source. The illumination falls on the area of interest and the event sensor including a pixel array 115 reports back on changes to the overall intensity as the incident wavelength changes. The method can be implemented in discrete steps as in the first and the second embodiments or using a continuous changing illumination source with similar analysis of resulting recorded data to achieve multi-spectral or hyperspectral imaging.

As described, the apparatus and the system disclosed in the present disclosure enables hyperspectral imaging using a filter assembly and an event camera. During the spectrum acquisition operation, the apparatus 100 is positioned such that the objects or areas of interest are in view of the apparatus 100. The apparatus 100 may be operated as a normal event camera at this stage, allowing event processing and neural algorithms to identify items of interest. Once the scene is established, the user initiates a capture either through a manual button on the apparatus, software or a wireless control signal. The apparatus 100 then initiates the spectra capture sequence and method as follows:
The filtering region of the filter assembly 110 starts without overlapping the N x M array.
As the filter assembly 110 moves, the filter assembly 110 partially overlaps the array, with

the blanking region intersecting a pixel's line of sight, reducing the incident intensity to zero.
The filter assembly 110 continues to move, overlapping the pixel, allowing light at the filter's wavelength to reach the pixel if present in the scene, generating one or more events if the light is transparent or partially transparent to the filter.
As the filter assembly 110 moves further, the filter assembly 110 presents either an increased or decreased wavelength value, leading to changes in intensity for the pixel and the creation of events that indicate an increase, decrease, or no change.
The filter assembly 110 continues to record intensity changes for all wavelengths relative to the previous intensity.
To complete the capture, the blanking region moves through, bringing the intensity back to zero for the pixel and creating event reports indicating the decrease in intensity.
The event data is recorded and structured into a 3D matrix.
Time values are correlated with wavelength values for each individual pixel.
A specific point in the scene is selected, and the event data for that pixel or a subset of pixels is integrated to generate a spectral curve of light emission from that point.
Spectral values may be corrected based on the illumination source, filter characteristics, and the absorption characteristics of the pixel material.
Additional spectra may be generated and combined to reduce noise, and lower event pixel bias values or slower raster speeds can be used to improve spectral resolution.
The event camera may also be configured to perform continuous spectral monitoring, using individual readings or generating running averages for high-speed applications.

In one embodiment of the present disclosure, the apparatus and the system disclosed in the present disclosure may be integrated into a mobile device for manual or automated inspection. A user may run a spectral measurement and select individual regions or pixels of a captured image to inspect the resulting spectra. The data may be further analyzed for known spectra or anomaly detection on objects or materials. Such an implementation offers an inexpensive and high-speed alternative to existing technologies that can be readily fine-tuned for specific applications (modifying wavelength band, extending wavelength band (NIR to UV)). A single camera may also record high-and low-resolution spectra by adjusting the event pixel bias and the filter raster speed.

It is to be noted that a polarization camera may also be created using a set of polarization filters or a continuous changing polarization lens, using the methods disclosed in the present disclosure. Further, using an attenuation filter, the event camera may be arranged to determine local intensities in a scene.

The apparatus, the system and the method disclosed in the present disclosure offer asynchronous data capture, eliminating the need for filter stepping correlated with frame rate. The system provides enhanced and reduced cost capabilities to factory lines by replacing high speed frame-based cameras. Furthermore, the system may be implemented for high-speed counting and identification of ingredients or components in a production line using their unique spectral signatures.

It is to be noted that the one or more parameters of the pixels (sensitivity, size of the pixel and the pixel array), the one or more optical parameters of the filter of the filter assembly (band pass filter, low pass filter, high pass filter, and Dichroic filter), and the one or more physical parameters of the filter of the filter assembly (discrete and linearly varying) are selected based on the requirements of the system and/or based on the application of the system. An example implementation is described below, and a few use cases are described. The specifics in the example and the use cases are merely a representation of a particular implementation, and it should be clear to the person skilled in the art that other parameters may be considered and used depending on the specific implementation required.

In one example, the filter may be 3 cm long and 1 cm wide and may include a 0.5 cm blanking area at start and/or end. The active area of the filter may be 2 cm with a linear varying band pass filter from, for example, 800 to 400 nm and the FWHM of the band may be 30 nm. The imaging area of the image sensor may be a 300×300 pixel array which may be 0.5 cm wide. The filter may move at 3.5 cm/sec, meaning the full wavelength range and the blanks may pass over each pixel in one second time frame and may be positioned between the focusing optic and near to the image sensor itself, for example, with less than 1 mm distance between the two when the filter is in front. A single pass of the filter assembly in front of the image sensor may be referred to as a ‘sweep’. In this implementation, a single sweep exposes each pixel to a gradient of the center wavelengths. The total wavelength exposure may be calculated by examining the wavelength gradient (wavelength/mm) and the pixel size (17 microns in this case). The total wavelength exposure may be determined by observing the bands across 17 microns of the filter (800 to 400=400 nm wavelength spread, 2 cm length indicates that 1 mm covers 20 nm). In this case the pixel is exposed to 0.34 nm spread of the center wavelengths. This is significantly smaller than the 30 nm FWHM, so the physical spatial spread may be ignored. However, for very compact linear filters and smaller FWHM values, the total wavelength exposure may limit resolution of the captured spectrum.

In the above exemplary implementation, the filter moves at 3.5 cm/sec. The movement may be translated to a wavelength/sec speed across the pixel, arriving at 700 nm/sec or 0.7 nm/ms. The event pixel has a time resolution of ~1 microsecond, however, following each event, the pixel has a refractory period of 1 ms. In such case, if the wavelength incident on the pixel changes by 0.7 nm/ms, the camera can substantially achieve 1 nm wavelength resolution as it may produce an event each millisecond and only see 0.7 nm of wavelength change during that time, aside from other optical effects. Due to other factors, the resolution is only applicable for monotonic changes within the bias value on a longer time scale. Very large changes in intensity (3× bias or more) will also be filtered as the slew rate of the system is limited by the single event for an intensity change followed by a refractory period.

While the pixel may be able to achieve 1 nm resolution, the FWHM of the filter (30 nm in the example) reduces the resolution. Rapid wavelength changes on the scale of the FWHM will not necessarily be recorded, for instance an incident wavelength peak that is only 10 nm in width, followed by a dip that is 10 nm in width will be smoothed out as the pixel can see the peak and the dip simultaneously due to the FWHM of the band pass filter. This may create artifacts that show a different spectrum shape in this region than anticipated. A tighter FWHM may increase resolution of local peaks and valleys. Alternatively, the wide FWHM will allow for more rapid acquisition (increased filter velocity) by expanding the wavelength region the pixel is exposed to, allowing more time to collect intensity in that wavelength region. Slow speeds are required for narrow band widths and steeper filter gradients, making a tradeoff between speed and resolution. If the speed is too slow, the pixel will be exposed to redundant wavelengths, if the speed is too fast the pixel may only ‘sample’ wavelengths due to is refractory period forcing to miss ranges of wavelengths entirely, providing an incomplete spectrum.

Discrete filter sets may be chosen for general spectrums (for example, the 10 center wavelength values across the visible spectrum) or may be chosen for a specific application where a spectrum of objects or materials is known (to identify different objects, one emitting in the 405 nm range and one in the 415 nm range) and objects or materials cannot be determined by eye, but a slightly different spectrum can identify them. Such filters are arranged in numerical order (high to low or low to high wavelengths) and should have similar general properties (transmission at center wavelength, FWHM, transmission at out of band wavelengths) unless only a small region of wavelength is of concern, then some of said requirements may be altered to reduce the cost and post-processing load.

Further, pixel bias may also impact the resolution and sensitivity of the measurement of the system. A smaller pixel bias, a low value of intensity change to trigger an event, provides a more sensitive detector, allowing for the recording of smaller scale changes in the incident intensity. However, this also increases overall noise in the system and would require slower filter speeds to achieve higher intensity resolution. Larger bias values may limit the resolution of the recorded spectrum amplitude, possibly missing smaller scale intensity changes and features in the spectrum.

In post processing of the data, corrections may be applied to increase resolution and reduce noise. For instance, if a linear varying filter is known to also have a non-uniform transmission percentage for out of band wavelengths (center wavelength of 450 nm, but known that the filter still transmits 5% of light for 780 nm), spectrum values may be corrected by correlating detected wavelengths and subtracting from other wavelengths. (for instance, if an emission peak is detected at 780 nm, the fact that only 5% of that light is transmitted through the filter at 780 nm can be corrected). The same technique may be applied for the spectrum of the illumination light, a user can point the hyperspectral camera at the illumination source (for instance a lamp) and collect its spectra, then collect the spectra from an object illuminated by that source. The source spectrum can be used to apply corrections to the measured object spectrum (for instance if the light source has a strong peak at 520 nm and a low illumination value in the target wavelength range). For precise measurements, using a known source or preferably a super continuum source, a correction spectrum for the pixels themselves can be collected and used for correction in all spectrum measurements. Existing noise algorithms for event-based data can also be applied to increase signal to noise ratio of the measured spectrum.

In an exemplary use case of discriminating two objects with identifying peaks moving quickly through the frame, a linear varying or discrete filter set that includes all prominent peaks may be used. For instance, one object may have peaks at 780 nm and 530 nm, while another has peaks at 810 nm and 560 nm. A set of four bandpass filters with a FWHM of 30 nm or less is selected for such cases. As the target peaks are few and speed is correlated to wavelength resolution, the system may operate at high speed, with filters that were physically narrow and moving such that each filter is above a pixel for 5 ms or greater. For this application, a spinning disk filter assembly or other similar higher speed configuration may be used.

In another exemplary use case of identification of minerals or the assessment of produce quality from their spectrum, a slower, and high-resolution system may be implemented, and the parameters are selected accordingly. For example, a linear varying band pass filter, with acquisition speeds at 1 sec or below may be implemented. A band pass filter with a narrow FWHM (5-10 nm or lower) may be used and the bias can be set to a small value if the capture environment is controlled.

In a telescopic attachment use case, bias may be reduced to a low value to accommodate the small amount of light from stars and planetary objects. A linear varying filter moving relatively slowly across the event sensor is optimal, with broad spectral range and the ability to move the filter such that ultra-high-resolution captures can be done swiftly in a region of interest of wavelength.

The written description describes the subject matter herein to enable any person skilled in the art to make and use the embodiments. The scope of the subject matter embodiments is defined by the claims and may include other modifications that occur to those skilled in the art. Such other modifications are intended to be within the scope of the claims if they have similar elements that do not differ from the literal language of the claims or if they include equivalent elements with insubstantial differences from the literal language of the claims.

The embodiments herein can comprise hardware and software elements. The embodiments that are implemented in software include but are not limited to, firmware, resident software, microcode, and the like. The functions performed by various modules described herein may be implemented in other modules or combinations of other modules. For the purposes of this description, a computer-usable or computer-readable medium can be any apparatus that can comprise, store, communicate, propagate, or transport the program for use by or in connection with the instruction execution system, apparatus, or device.

A description of an embodiment with several components in communication with each other does not imply that all such components are required. On the contrary, a variety of optional components are described to illustrate the wide variety of possible embodiments of the disclosure. When a single device or article is described herein, it will be apparent that more than one device/article (whether or not they cooperate) may be used in place of a single device/article. Similarly, where more than one device or article is described herein (whether or not they cooperate), it will be apparent that a single device/article may be used in place of the more than one device or article, or a different number of devices/articles may be used instead of the shown number of devices or programs. The functionality and/or the features of a device may be alternatively embodied by one or more other devices which are not explicitly described as having such functionality/features. Thus, other embodiments of the disclosure need not include the device itself.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments. Also, the words “comprising,” “having,” “containing,” and “including,” and other similar forms are intended to be equivalent in meaning and be open-ended in that an item or items following any one of these words is not meant to be an exhaustive listing of such item or items or meant to be limited to only the listed item or items. It must also be noted that as used herein and in the appended claims, the singular forms “a”, “an”, and “the” include plural references unless the context clearly dictates otherwise.

Finally, the language used in the specification has been principally selected for readability and instructional purposes, and it may not have been selected to delineate or circumscribe the inventive subject matter. It is therefore intended that the scope of the disclosure be limited not by this detailed description, but rather by any claims that issue on an application based here on. Accordingly, the embodiments of the present disclosure are intended to be illustrative, but not limited, of the scope of the disclosure, which is outlined in the following claims.

What is claimed is:

1. An apparatus, comprising:
an optical focusing component to capture and focus incident light from an object in a scene;
a multi-band spectral filter assembly to receive and filter the incident light from the optical focusing component;
an event sensor including a pixel array to detect one or more events, including sensing a change in relative intensity over time for filtered light received from the multi-band spectral filter assembly; and
a filter assembly driver to sweep the multi-band spectral filter assembly in front and across the pixel array of the event sensor, and along a plane of motion perpendicular to the multi-band spectral filter assembly.

2. The apparatus of claim 1, wherein detection of the one or more events is based on a comparison of the change in relative intensity over time to an incident wavelength.

3. The apparatus of claim 1, wherein detection of the one or more events is associated with a spectral characteristic of the object in the scene.

4. The apparatus of claim 1, wherein the multi-band spectral filter assembly is located in between the optical focusing component and the event sensor.

5. The apparatus of claim 1, wherein a filter region of the multi-band spectral filter assembly is discrete.

6. The apparatus of claim 1, wherein a filter region of the multi-band spectral filter assembly is linearly varying.

7. The apparatus of claim 1, wherein the multi-band spectral filter assembly is a linear variable bandpass filter.

8. The apparatus of claim 1, wherein the multi-band spectral filter assembly is one of a low pass filter, a high pass filter, and a dichroic filter.

9. The apparatus of claim 1, wherein the multi-band spectral filter assembly includes a plurality of filters sequenced in increasing or decreasing wavelength order.

10. The apparatus of claim 1, wherein the change in relative intensity over time is associated with one or more of a polarity of the change in relative intensity, a time of the change in relative intensity over time, and a pixel location associated with the change in relative intensity over time.

11. The apparatus of claim 1, wherein the filter assembly driver sweeps the multi-band spectral filter assembly at an adjustable speed.

12. The apparatus of claim 1, wherein the filter assembly driver sweeps the multi-band spectral filter assembly in front and across the pixel array of the event sensor in one of a single-sweep motion, a rotational sweep motion, and a back-and-forth sweep motion.

13. The apparatus of claim 1, wherein the multi-band spectral filter assembly is tunable to one or more desired wavelength bands.

14. A system, comprising:
a processor;
an event camera, comprising:
an optical focusing component to capture and focus incident light from an object in a scene;
a multi-band spectral filter assembly to receive and filter the incident light from the optical focusing component;
an event sensor including a pixel array to detect one or more events, including sensing a change in relative intensity over time for filtered light received from the multi-band spectral filter assembly; and
a filter assembly driver to sweep the multi-band spectral filter assembly in front and across the pixel array of the event sensor, and along a plane of motion perpendicular to the multi-band spectral filter assembly;
a display device; and
a non-transitory memory device storing instructions, wherein the instructions are executable by the processor to:
generate a multi-dimensional data matrix of event intensity values over time, wherein the event intensity values are associated with detection of the one or more events;
identify an aspect of interest associated with the object in the scene based on analysis of the multi-dimensional data matrix; and
display the aspect of interest associated with the object in the scene on the display device.

15. The system of claim 14, wherein the instructions are executed in association with implementation of a neural network (NN), and wherein the aspect of interest associated with the object in the scene is one of a spectrum of the objects in the scene and a polarity of the objects in the scene.

16. The system of claim 14, wherein the instructions are further executable by the processor to compare the change in relative intensity over time to an adjustable bias value to enable detection of the one or more events.

17. The system of claim 14, wherein the multi-band spectral filter assembly is located in between the optical focusing component and the event sensor.

18. A method for event-based imaging and monitoring, the method comprising:
capturing and focusing incident light from an object in a scene;
sweeping a multi-band spectral filter assembly in front and across a pixel array of an event sensor, and along a plane of motion perpendicular to the multi-band spectral filter assembly; and
filtering, via the multi-band spectral filter assembly, the incident light to detect one or more events, including sensing a change in relative intensity over time for filtered light received from the multi-band spectral filter assembly.

19. The method of claim 18, further comprising:
generating a multi-dimensional data matrix of event intensity values over time, wherein the event intensity values are associated with detection of the one or more events;
generating a spectrum of incident light for each pixel of the pixel array;
and
identifying an aspect of interest associated with the object in the scene based on analysis of the multi-dimensional data matrix.

20. The method of claim 18, wherein detection of the one or more events is associated with a spectral characteristic of the object in the scene.
